(19) United States
(12) Patent Application Publication
(10) Pub. No.: US 2023/0072139 A1
(43) Pub. Date: Mar. 9, 2023

(54) WIDE-BAND DUAL-POLARIZED STRIP PATCH DIPOLE ANTENNA

(71) Applicant: Mobix Labs, Inc., Irvine, CA (US)

(72) Inventors: Meysam Moallem, Irvine, CA (US); Saeideh Shad, Irvine, CA (US)

(21) Appl. No.: 17/931,035

(22) Filed: Sep. 9, 2022

Related U.S. Application Data
(62) Division of application No. 17/931,025, filed on Sep. 9, 2022.
(60) Provisional application No. 63/242,374, filed on Sep. 9, 2021.
(60) Provisional application No. 63/242,376, filed on Sep. 9, 2021.

(51) Int. Cl. H01Q 21/06; H01Q 9/04; H01Q 21/26

(52) U.S. Cl. CPC H01Q 21/065; H01Q 9/0414; H01Q 21/062; H01Q 21/26

(57) ABSTRACT

A dual/tri-band array antenna for multiple frequency bands has one or more shared aperture unit cells, and a plurality of dual-polarized magneto-electric dipole antennas or aperture-fed stacked patch antennas configured for signals of the high band(s). A given set of the dual-polarized magneto-electric dipole antennas or aperture-fed stacked patch antennas are positioned on a given one of the shared aperture unit cells in a spaced apart relationship. The array antenna has one or more dual-polarized crossed dipole patch antennas configured for the low band. A given one of the dual-polarized crossed dipole patch antennas are centered on the given one of the shared aperture unit cells and spaced apart from the dual-polarized magneto-electric dipole antennas or aperture-fed stacked patch antennas.

### CROSS-REFERENCE TO RELATED APPLICATIONS

This application relates to and claims the benefit of U.S. Provisional Application No. 63/242,374 filed Sep. 9, 2021 and entitled “A TM-BAND (KA & V) ANTENNA ARRAY ON A SHARED APERTURE,” and U.S. Provisional Application No. 63/242,376 filed Sep. 9, 2021 and entitled “WIDE-BAND DUAL-POLARIZED STRIP PATCH DIPOLE, the entire disclosure of each of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to radio frequency (RF) devices, and more particularly, to dual-band/tri-band antenna arrays on a shared aperture.

### 2. Related Art

Wireless communications systems find applications in numerous contexts involving information transfer over long and short distances alike, and a wide range of modalities tailored for each need have been developed. Generally, wireless communications utilize a radio frequency carrier signal that is modulated to represent data, and the modulation, transmission, receipt, and demodulation of the signal conform to a set of standards for coordination of the same. Many different mobile communication technologies or air interfaces exist, including GSM (Global System for Mobile Communications), EDGE (Enhanced Data rates for GSM Evolution), and UMTS (Universal Mobile Telecommunications System).

Various generations of these technologies exist and are deployed in phases, the latest being the 5G broadband cellular network system. 5G is characterized by significant improvements in data transfer speeds resulting from greater bandwidth that is possible because of higher operating frequencies compared to 4G and earlier standards. The air interfaces for 5G networks are comprised of two frequency bands, frequency range 1 (FR1), the operating frequency of which being below 6 GHz with a maximum channel bandwidth of 100 MHz, and frequency range 2 (FR2), the operating frequency of which being above 24 GHz with a channel bandwidth between 50 MHz and 400 MHz. The latter is commonly referred to as millimeter wave (mmWave) frequency range. Although the higher operating frequency bands, and mmWave/FR2 in particular, offer the highest data transfer speeds, the transmission distance of such signals may be limited. Furthermore, signals at this frequency range may be unable to penetrate solid obstacles and be subject to air propagation loss and oxygen absorption. To overcome these limitations while accommodating more connected devices, various improvements in cell site and mobile device architectures have been developed.

One such improvement is the use of multiple antennas at both the transmission and reception ends, also referred to as MIMO (multiple input, multiple output), which is understood to increase capacity density and throughput. A series of antennas may be arranged in a single or multi-dimensional array, and further, may be employed for beamforming where radio frequency signals are shaped to point in a specified direction of the receiving device. A single transmitter circuit can feed the signal to each of the antennas individually through splitters, with the phase of the signal as radiated from each of the antennas being varied over the span of the array. There are variations in which multiple transmitter circuits that can feed each antenna or a group of antennas. The collective signal radiated from the individual antennas may have a narrower beam width, and the direction of the transmitted beam may be adjusted based upon the constructive and destructive interferences of the signals radiated from each antenna resulting from the phase shifts. Beamforming may be used in both transmission and reception, and the spatial reception sensitivity may likewise be adjusted.

Within the FR2/millimeter wave frequency range of the 5G mobile network standard, there are further discrete frequency bands with defined bandwidths. The n257 band spans the 26.5 GHz to 29.5 GHz frequency range, the n258 band extends from 24.25 GHz to 27.50 GHz, the n259 band extends from 39.50 GHz to 43.50 GHz, the n260 band extends from 37.00 GHz to 40.00 GHz, the n261 band extends from 27.50 GHz to 28.35 GHz, and the n262 band extends from 47.20 GHz to 48.20 GHz. In order to maximize data throughput, there is a need for service providers to transmit and receive at both high band and low band simultaneously, and so antennas capable of such functionality are needed. Further improvements in interference reduction and capacity increases are possible with antennas having multiple polarizations, including vertical/horizontal polarizations, circular polarization, and elliptical polarization that correspond to the physical orientation of the radio frequency waves radiating therefrom. Conventional 5G millimeter wave beamformer systems employ antennas with vertical polarization and horizontal polarization, and so it would be desirable for the multi-frequency transmit/receive antennas to handle both vertical and horizontal polarizations concurrently.

The present disclosure will be best understood accompanying by reference to the following detailed description when read in conjunction with the drawings.

### BRIEF SUMMARY

The present disclosure is directed to various embodiments of multi-band antenna arrays and antenna elements utilized therein for Ka and V band operating frequencies.

According to one embodiment of the present disclosure, there may be a dual/tri-band array antenna for a high band operating frequency band and a low band operating frequency band. There may be one or more shared aperture unit cells. There may also be a plurality of dual-polarized magneto-electric dipole antennas. A given set of the dual-polarized magneto-electric dipole antennas may be positioned on a given one of the shared aperture unit cells in a spaced apart relationship and configured for signals of the high band operating frequency band. There may also be one or more dual-polarized crossed dipole patch antennas. A given one of the dual-polarized crossed dipole patch antennas may be centered on the given one of the shared aperture unit cells and spaced apart from the dual-polarized magneto-electric dipole antennas and configured for signals of the low band operating frequency band.

Another embodiment of the present disclosure may be a dual-band array antenna for a high-band operating frequency band and a low-band operating frequency band. The array antenna may include one or more shared aperture unit cells, a plurality of dual-polarized aperture-fed stacked patch antennas, and one or more dual-polarized crossed dipole patch antennas. A given set of the dual-polarized aperture-fed stacked patch antennas may be positioned on a given one of the shared aperture unit cells in a spaced apart relationship and configured for signals of the high-band operating frequency band. A given one of the dual-polarized crossed dipole patch antennas may be centered on the given one of the shared aperture unit cells and spaced apart from other ones of the dual-polarized aperture-fed stacked patch antennas on the given one of the shared aperture unit cells and configured for signals of the low-band operating frequency band.

Another embodiment of the present disclosure contemplates a radio frequency transmit-receive module. There may be a multi-layer laminate structure array antenna that is defined by one or more shared aperture unit cells. Each of the shared aperture unit cells may include a plurality of dual-polarized first antennas. A given set of the dual-polarized first antennas may be positioned on a given one of the shared aperture unit cells in a spaced apart relationship and configured for signals of one or more high-band operating frequency bands. There may also be one or more dual-polarized second antennas. A given one of the dual-polarized second antennas may be centered on the given one of the shared aperture unit cells and spaced apart from other ones of the dual-polarized first antennas on the given one of the shared aperture unit cells. The dual-polarized second antennas may be configured for signals of a low-band operating frequency band. The RF transmit-receive module may also include one or more beamformer integrated circuit that is attached to the multi-layer laminate structure.

In accordance with another embodiment of the present disclosure, there may be a dual-polarized antenna. The antenna may include a first antenna ground layer, as well as a vertical strip patch dipole element on a first intermediate layer and a vertical strip patch via that may be connected to the vertical strip patch dipole element and the first antenna ground layer. The antenna may further include a horizontal strip patch dipole element on a second intermediate layer, which may be oriented perpendicularly to the vertical strip patch dipole element and overlap at respective central portions of the horizontal strip patch dipole element and the vertical strip patch dipole element. There may be a horizontal strip patch via that is connected to the horizontal strip patch dipole element and the first antenna ground layer. The antenna may further include a parasitic cross-patch dipole on a top layer, which may be centered above the horizontal strip patch dipole element and the vertical strip patch dipole element. Additionally, the antenna may include a cross-patch via that is connected to the parasitic cross-patch dipole and the vertical strip patch dipole element.

Still another embodiment of the present disclosure may be a dual-polarized antenna. The antenna may include a main cross-patch dipole that is defined by a horizontal polarization patch element and a vertical polarization patch element offset from and oriented perpendicularly to each other. The antenna may also include patch element vias that are connected to the horizontal polarization patch element and to the vertical polarization patch element, along with a parasitic cross-patch dipole centered above the main cross-patch dipole. Other embodiments of the present disclosure contemplate a radio frequency transmit-receive module including a beamformer integrated circuit and the dual polarized-antenna.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top plan view of a dual/tri-band antenna array on a shared aperture in accordance with one embodiment of the present disclosure;

FIG. 2 is a top plan view of a first implementation of the shared aperture unit cell of the dual/tri-band antenna array according to an embodiment of the present disclosure;

FIG. 3 is a bottom plan view of a radio frequency transmit-receive circuit incorporating the dual/tri-band antenna array with the first implementation of the shared aperture unit cell;

FIG. 4 is a top plan view of a second implementation of the shared aperture unit cell of the dual/tri-band antenna array;

FIG. 5 is a bottom plan view of the radio frequency transmit-receive circuit incorporating the dual/tri-band antenna array with the second implementation of the shared aperture unit cell;

FIG. 6 is a top plan view of the dual/tri-band antenna array as scalable to an arbitrary size;

FIG. 7 is a perspective view of a dual-polarized, strip patch dipole antenna according to another embodiment of the present disclosure;

FIG. 8 is a side view of the dual-polarized, strip patch dipole antenna;

FIG. 9A is a simulated antenna radiation plot of the dual-polarized strip patch dipole antenna at an operating frequency of 28 GHz with horizontal polarization;

FIG. 9B is a simulated antenna radiation plot of the dual-polarized strip patch dipole antenna at an operating frequency of 28 GHz with vertical polarization;

FIG. 10A is a simulated antenna radiation plot of the dual-polarized strip patch dipole antenna at an operating frequency of 24.5 GHz with horizontal polarization;

FIG. 10B is a simulated antenna radiation plot of the dual-polarized strip patch dipole antenna at an operating frequency of 24.5 GHz with vertical polarization;

FIG. 11 is a graph plotting the simulated input return loss and insertion loss of the dual-polarized strip patch dipole antenna;

FIG. 12 is a perspective view of a dual-polarized, strip patch dipole antenna according to another embodiment of the present disclosure;

FIG. 13 is a side view of the dual-polarized, strip patch dipole antenna;

FIG. 14A is a simulated antenna radiation plot of the dual-polarized strip patch dipole antenna at an operating frequency of 28 GHz with horizontal polarization;

FIG. 14B is a simulated antenna radiation plot of the dual-polarized strip patch dipole antenna at an operating frequency of 28 GHz with vertical polarization;

FIG. 15A is a simulated antenna radiation plot of the dual-polarized strip patch dipole antenna at an operating frequency of 24.5 GHz with horizontal polarization;

FIG. 15B is a simulated antenna radiation plot of the dual-polarized strip patch dipole antenna at an operating frequency of 24.5 GHz with vertical polarization; and

FIG. 16 is a graph plotting the simulated input return loss and insertion loss of the dual-polarized strip patch dipole antenna.

### DETAILED DESCRIPTION

The present disclosure is directed to various embodiments of antenna arrays and antenna elements therefor configured for millimeter wave operating frequency bands in the Kₐ and V portions of the spectrum. Some embodiments may be utilized in next generation 5G beamformer applications, which have designated operating frequency bands as mentioned previously. According to one contemplated embodiment, the term high band 1 (HB1) may be used to refer to those operating frequencies between 37 GHz to 43.5 GHz, while the term high band 2 (HB2) may be used to refer to those operating frequencies between 43.5 GHz to 49 GHz. Furthermore, low band (LB) may be used to refer to those operating frequencies between 24.25 GHz to 29.5 GHz. Relative to the published 5G mmWave bands, LB may correspond to portions of the n257 band, the n258 band, and the n261 band, whereas HB1 may correspond to portions of the n259 band and the n260 band, and the HB2 may correspond do portions of the n259 band and the n262 band. The antenna arrays/antennas are contemplated to transmit and receive signals across these bands, with both horizontal polarization and vertical polarization.

The embodiments of the present disclosure will be described in the context of the 5G mmWave operating environment and the aforementioned frequency bands, though it will be appreciated by those having ordinary skill in the art that the antenna arrays and antenna elements therein may be adopted to other operating environments, particularly with other microwave systems possibly having different frequency bands. Suitable modifications to the antenna array and antenna element structures for adaptation to such alternative operating environments are deemed to be within the purview of the present disclosure, with reference to specific operating frequency bands corresponding to other frequency bands/ranges.

The detailed description set forth below in connection with the appended drawings is intended as a description of the several presently contemplated embodiments of the antennas, antenna arrays, and transmit-receive circuits and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second, proximal and distal, left and right, top and bottom, upper and lower, and the like are used solely to distinguish one from another entity without necessarily requiring or implying any actual such relationship or order between such entities.

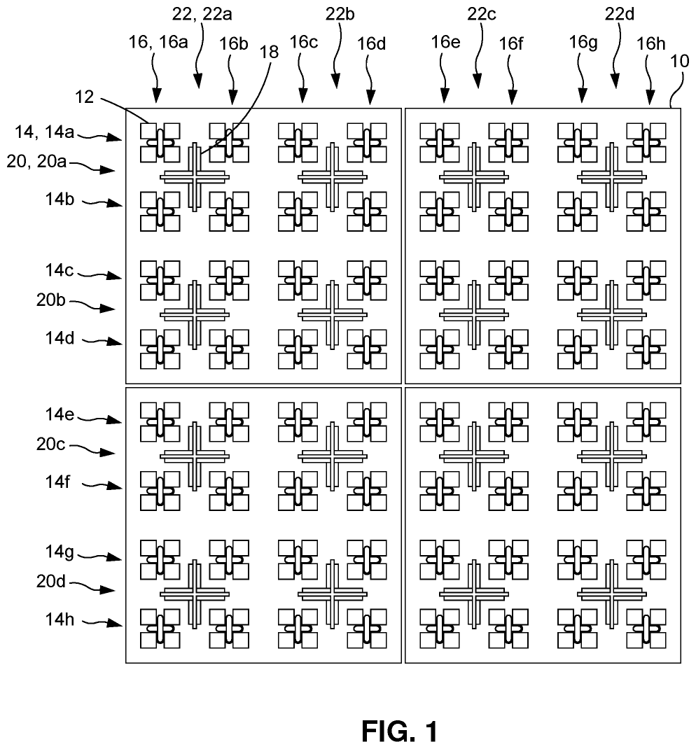

With reference to FIG. 1, one embodiment of the present disclosure contemplates a dual/tri-band antenna array 10 for transmitting and receiving 5G mmWave signals in the HB band and the LB band. In some embodiments, the HB band may span both the HB1 and HB2 operating frequency bands between 37 GHz to 49 GHz, just the HB1 band between 37 GHz to 43.5 GHz, or just the HB2 band between 43.5 GHz to 49 GHz. In order to support this wide bandwidth between 24.25 GHz and 49 GHz, separate antenna elements may be utilized for the 24.25 GHz to 29.5 GHz band and 37 GHz to 49 GHz band. This is envisioned to improve coverage across the entirety of the 5G mmWave spectrum, while providing sufficient isolation between these bands.

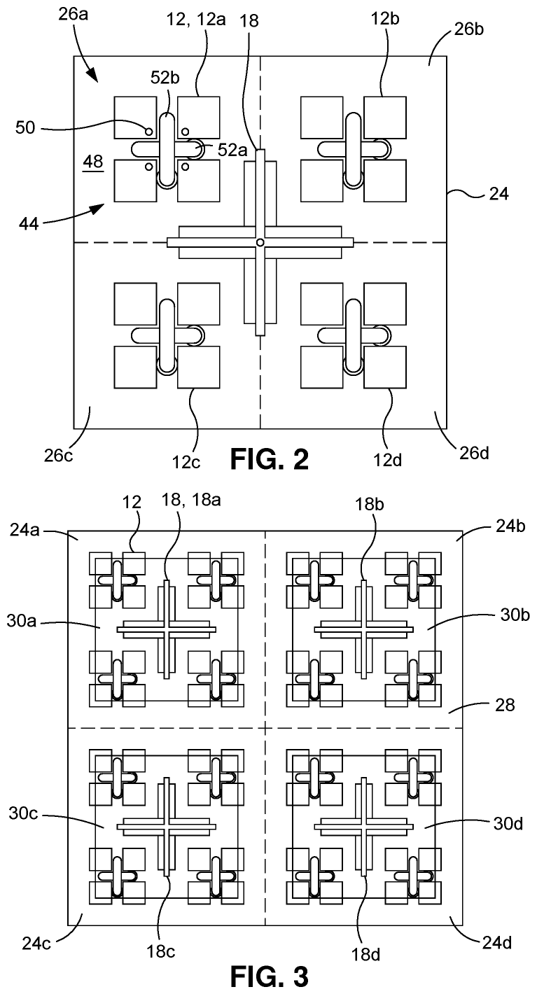

The dual/tri-band antenna array 10 may be comprised of multiple high band antenna array elements 12 that are arranged in equally spaced rows 14 and columns 16. The high band antenna array elements 12 are understood to be configured and tuned for transmit and receive operation in the entirety of the HB band, just the HB1 band, or just the HB2 band, spanning the operating frequencies between 37 GHz and 49 GHz. In addition, the high band antenna array elements 12 are configured for both horizontal and vertical polarizations for each of the HB/HB1/HB2 band. According to one embodiment, the high band antenna array elements 12 may be a dual-polarized magneto-electric dipole antenna 44. With additional reference to FIG. 2, this may be generally defined by a set of horizontal patches 46 that each have a rectangular shape of equal size and positioned equidistant from other patches in the vertical and horizontal direction. The horizontal patches 46 are connect to a ground plane 48 by vias 50 and are excited by a horizontal polarization probe 52a and a vertical polarization probe 52b that are each connected to signal feeds. As utilized herein, operating refers to both transmit and receive operations, and the embodiments of the present disclosure contemplate receiving and transmitting horizontally and vertically polarized signals in the high band and the low band, all simultaneously or one at a time, whichever specific frequency bands they may be.

The example configuration of FIG. 1 shows eight rows 14 of the high band antenna array elements 12, including a first row 14a, a second row 14b, a third row 14c, a fourth row 14d, a fifth row 14e, a sixth row 14f, a seventh row 14g, and an eighth row 14h. Additionally, there are eight columns 16 of the high band antenna array elements 12, including a first column 16a, a second column 16b, a third column 16c, a fourth column 16d, a fifth column 16e, a sixth column 16f, a seventh column 16g, and an eighth column 16h. This arrangement and number of rows 14/columns 16 of the high band antenna array elements 12 is by way of example only and not of limitation, and it is expressly contemplated that the dual/tri-band antenna array 10 may be expanded with an arbitrary number of high band antenna array elements 12.

The dual/tri-band antenna array 10 may also include multiple low band antenna array elements 18 that are similarly arranged in equally spaced rows 20 and columns 22. The low band antenna array elements 18 are configured and tuned for transmit and receive operation in the LB band, spanning the operating frequencies between 24.25 GHz and 29.5 GHz. Like the high band antenna array elements 12, the low band antenna array elements 18 are configured for both horizontal and vertical polarizations. In one embodiment, the low band antenna array elements 18 may be a dual-polarized crossed dipole patch antenna, the details of which are described more fully below. The example configuration of FIG. 1 shows four rows 20 of the low band antenna array elements 18, including a first row 20a, a second row 20b, a third row 20c, and a fourth row 20d. There are also four columns 22 of the low band antenna array elements 18, including a first column 22a, a second column 22b, a third column 22c, and a fourth column 22d. This arrangement and number of rows 20/columns 22 of the low band antenna array elements 18 is by way of example only and not of limitation, and it is expressly contemplated that the dual/tri-band antenna array 10 may be expanded with an arbitrary number of low band antenna array elements 18.

Referring now to FIG. 2, according to one embodiment, the foundational element of the dual/tri-band antenna array 10 is a shared aperture unit cell 24 that includes a 2×2 array of the high band antenna array elements 12 and one of the low band antenna array elements 18. The shared aperture unit cell 24 is understood to be quadrilateral of equal lengths, i.e., square-shaped, with the low band antenna array element 18 being located in the center thereof. As will be considered in further detail below, the low band antenna array element 18 is cross-shaped and segregates the shared aperture unit cell 24 into four broad quadrants: an upper left quadrant 26a, an upper right quadrant 26b, a lower left quadrant 26c, and a lower right quadrant 26d. A first high band antenna array element 12a is centered in the upper left quadrant 26a, a second high band antenna array element 12b is centered in the upper right quadrant 26b, a third high band antenna array element 12c is centered in the lower left quadrant 26c, and a fourth high band antenna array element 12d is centered in the lower right quadrant 26d.

In the illustrated embodiment, the pitch, or separation between one of the high band antenna array elements 12 is understood to be 3 mm. That is, there is a 3 mm left-to-right separation between the respective centers of the first high band antenna array element 12a and the second high band antenna array element 12b, as well as between the respective centers of the third high band antenna array element 12c and the fourth high band antenna array element 12d. Moreover, there is a 3 mm top-to-bottom separation between the respective centers of the first high band antenna array element 12a and the third high band antenna array element 12c, as well as between the respective centers of the second high band antenna array element 12b and the fourth high band antenna array element 12d. The pitch specification is generally correlated to the wavelength of the signal to be transmitted and received by the antenna. In this example, separation distance (3 mm) is selected to be smaller than half of the wavelength at the maximum high band operating frequency (49 GHz), to avoid grating lobes in the radiation pattern over the entire beamforming range. It is understood that separation distances may be selected depending on isolation, field-of-view, or other requirements.

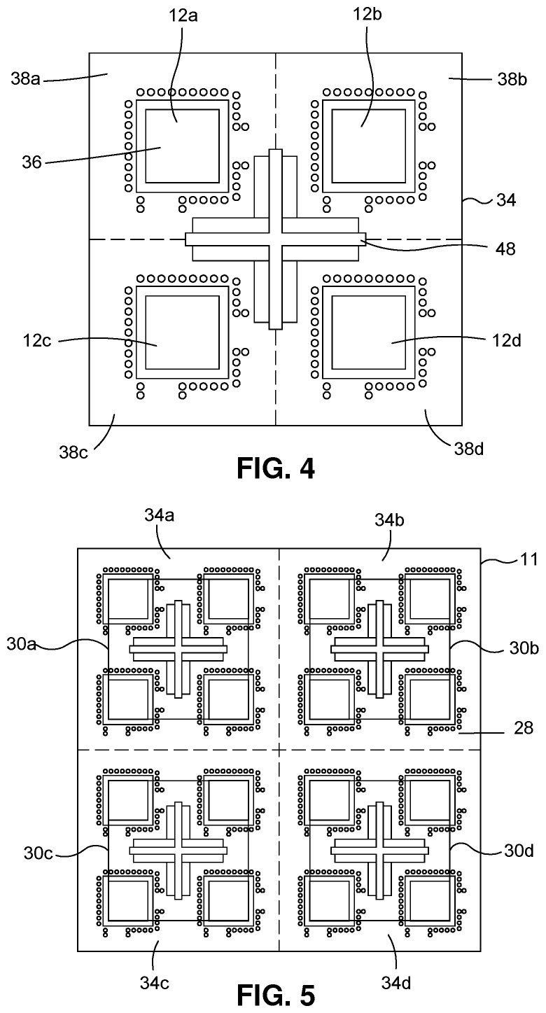

As shown in FIG. 3, with the shared aperture unit cell 24 being the foundational building block, multiple ones may be tiled to define the dual/tri-band antenna array 10. In this example, there are four shared aperture unit cells 24, including a first shared aperture unit cell 24a, a second shared aperture unit cell 24b, a third shared aperture unit cell 24c, and a fourth shared aperture unit cell 24, with a total of sixteen high band antenna array elements 12 and four low band antenna array elements 18. Because each shared aperture unit cell 24 has only a single low band antenna array element 18, the separation between each is essentially the separation between given ones of the shared aperture unit cells 24. In the illustrated example, the pitch, or separation distance between one of the low band antenna array elements 18 and another is 6 mm. That is, the top-to-bottom separation between a low band antenna array element 18a for the first shared aperture unit cell 24a and a low band antenna array element 18c for the third shared aperture unit cell 24b, as well as between a low band antenna array element 18b for the second shared aperture unit cell 24b and a low band antenna array element 18d for the fourth shared aperture unit cell 24d is 6 mm. Likewise, the left-to-right separation between the low band antenna array element 18a and the low band antenna array element 18b, as well as between the low band antenna array element 18c and the low band antenna array element 18c, is also 6 mm.

The dual/tri-band antenna array 10 may be implemented as a multi-layer laminate structure. The outline of the dual/tri-band antenna array 10 shown in FIG. 3 may thus represent the boundaries of a printed circuit board (PCB) substrate 28. The dual/tri-band antenna array 10 may be part of a radio frequency (RF) transmit-receive module of a wireless communications system. In some cases, it may be beneficial for a beamformer integrated circuit to be placed in close physical proximity to an antenna array element specific thereto so that transmission line losses and distortion may be minimized. It will be recognized by those having ordinary skill in the art that a beamformer IC may include phase shifters, splitter/combiner circuits, and various amplifiers (power amplifiers, low noise amplifiers, variable gain amplifiers) and so on. Affixed to one side of the PCB substrate 28 may be such a beamformer IC 30, centered on the shared aperture unit cell 24 corresponding to the antenna elements to which it is connected. Specifically, the first shared aperture unit cell 24a may be connected to a first beamformer IC 30a and is mounted in the center thereof. The second shared aperture unit cell 24b may be connected to a second beamformer IC 30b and is mounted in the center thereof. The third shared aperture unit cell 24c may be connected to a third beamformer IC 30c and is mounted in the center thereof. Lastly, the fourth shared aperture unit cell 24d may be connected to a fourth beamformer IC 30d and is mounted in the center thereof. This configuration of the beamformer ICs 30 and their attachment to the PCB substrate 28 is presented by way of example only and not of limitation. The illustrated example contemplates eight high band channels to support the 2×2 array of dual polarized high band elements and two low band channels for the single dual polarized low band element in the shared aperture unit cell 24. Other configurations/implementations may involve different low band and high band channels, and the corresponding beamformer ICs may be placed in a different configuration on the PCB substrate 28.

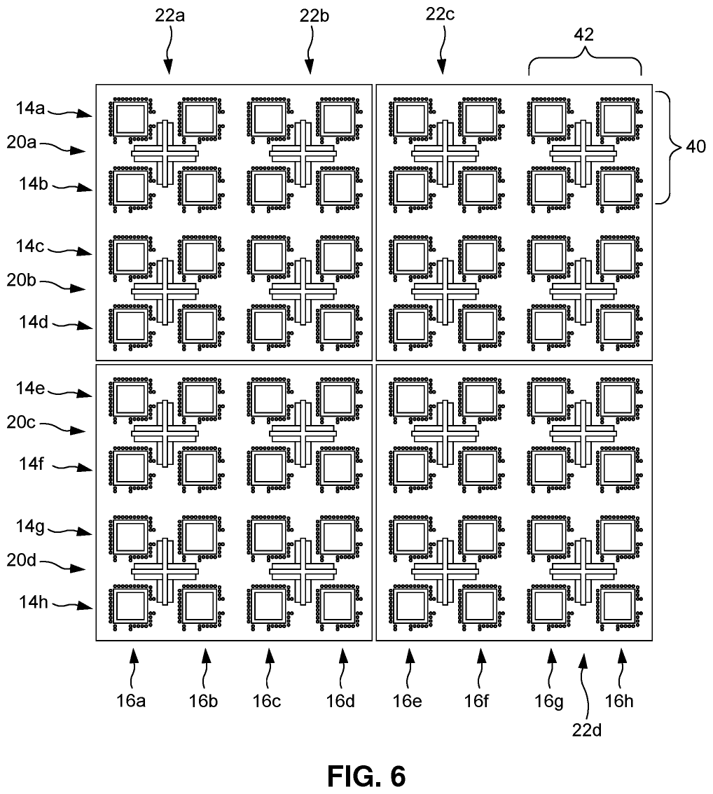

Configurations alternative to the above-described embodiment of the shared aperture unit cell 24 utilizing the dual-polarized magneto-electric dipole antenna 44 are also contemplated. With reference to FIG. 4, an alternative shared aperture unit cell 34 incorporates a dual-polarized aperture-fed stacked patch antenna 36. As a general matter, this antenna structure may also be referred to as a high band antenna array element 12, though it is configured and optimized to cover only the full 5G mmWave high band 1 (HB1) band spanning the operating frequency range of 37 GHz to 43.5 GHz with both horizontal and vertical polarizations. Similar to the first embodiment, there is a 2×2 array of the high band antenna array elements 12 and the same low band antenna array element 18, which is configured and optimized for coverage of the entire 5G mmWave LB operating frequency band.

Two possible variants of the high band antenna array element 12 have been disclosed, that is, the dual-polarized magneto-electric dipole antenna 44, and a dual-polarized aperture-fed stacked patch antenna 36. It is to be understood that these two variations are presented by way of example only and not of limitation, and any other suitable structure for HB/HB1/HB2 operation may be substituted without departing from the scope of the present disclosure.

Again, the shared aperture unit cell 24 may be a quadrilateral of equal lengths, i.e., square-shaped, with the low band antenna array element 18 being centered thereon. A first high band antenna array element 12a is centered in the upper left quadrant 38a, a second high band antenna array element 12b is centered in the upper right quadrant 38b, a third high band antenna array element 12c is centered in the lower left quadrant 38c, and a fourth high band antenna array element 12d is centered in the lower right quadrant 38d. The pitch or separation between each of the high band antenna array elements 12 may be 3 mm in accordance with one embodiment of the present disclosure, as this configuration is contemplated to avoid grating lobes in the radiation pattern over the entire beamforming range.

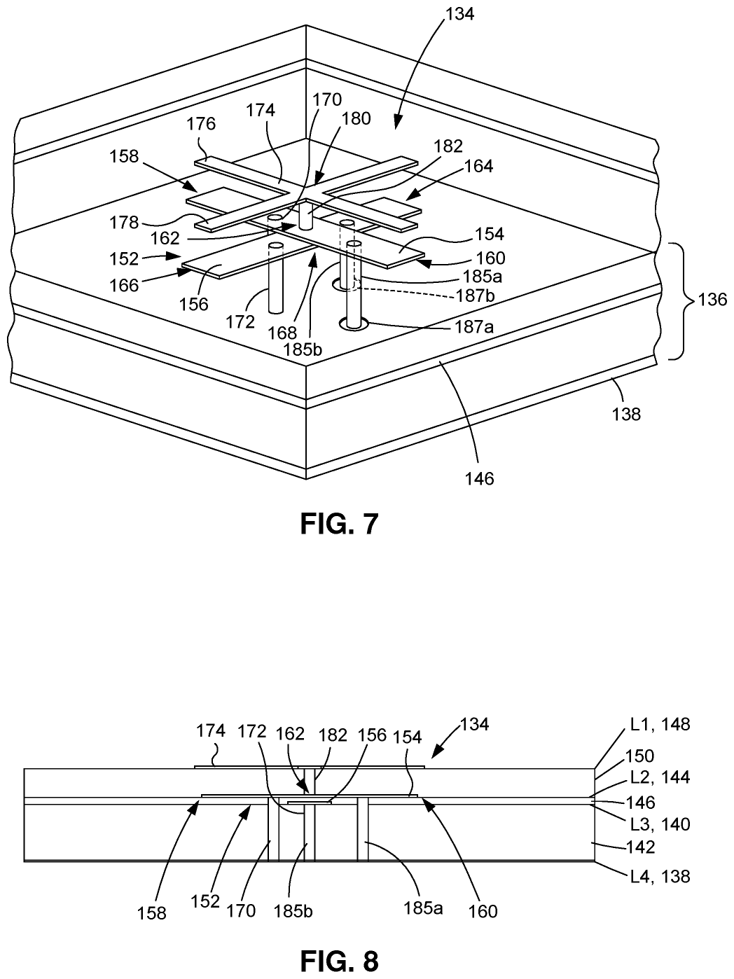

Referring now to FIG. 5, the shared aperture unit cell 34 may be tiled to expand a dual band antenna array 11 to an arbitrary size. Like the dual/tri-band antenna array 10 discussed above, the dual band antenna array 11 may be implemented as a multi-layer laminate structure, which includes the underlying printed circuit board substrate 28. In this example, four shared aperture unit cells 34 are provided, including a first shared aperture unit cell 34a positioned in an upper left quadrant of the substrate 28, a second shared aperture unit cell 34b on the upper right quadrant, a third shared aperture unit cell 34c on the bottom left quadrant, and a fourth shared aperture unit cell 34d on the bottom right quadrant.

As each shared aperture unit cell 34 includes only a single low band antenna array element 18, the pitch or separation between each one in the dual band antenna array 11 corresponds to that of the spacing between the shared aperture unit cells 34. According to one embodiment of the present disclosure, the top-to-bottom spacing between two vertically adjacent low band antenna array elements 18 as well as the left-to-right spacing between two laterally adjacent low band antenna array elements 18 is 6 mm, though this value is presented by way of example only and not of limitation.

The dual band antenna array 11 may also incorporate the beamformer IC 30 directly on the substrate 28, with one being provided for each shared aperture unit cell 34. In further detail, the first beamformer IC 30a may be mounted to the center of the first shared aperture unit cell 34a, the second beamformer IC 30b may be mounted to the center of the second shared aperture unit cell 34b. the third beamformer IC 30c may be mounted to the center of the third shared aperture unit cell 34c, and the fourth beamformer IC 30d may be mounted to the center of the fourth shared aperture unit cell 34d. Again, this configuration of the beamformer ICs 30 and their attachment to the PCB substrate 28 is presented by way of example only and not of limitation. Other configurations/implementations may involve different low band and high band channels, and the corresponding beamformer ICs may be placed in a different configuration on the PCB substrate 28.

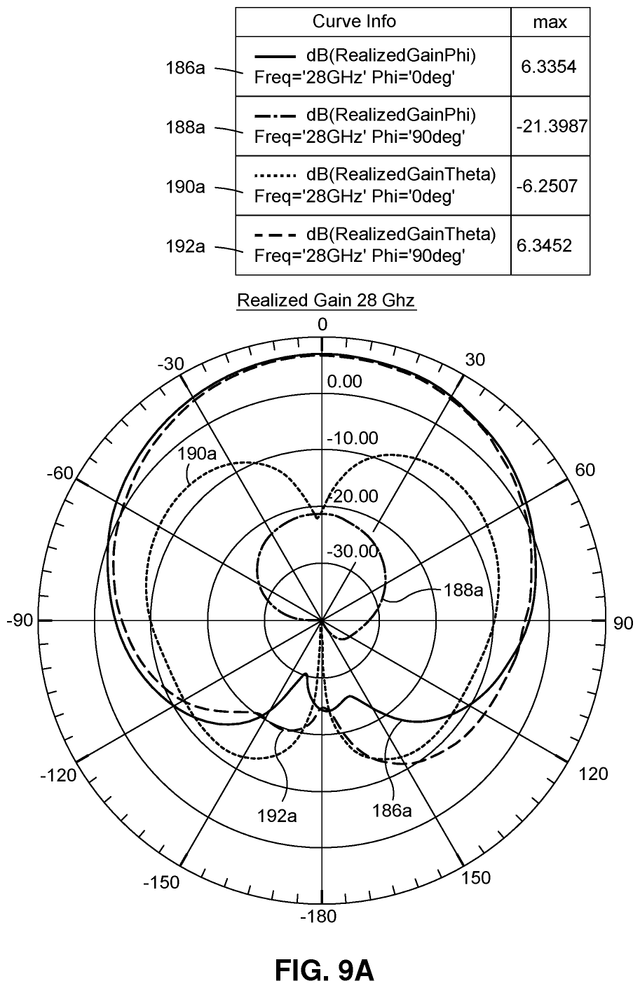

With the 2×2 arrangement of the dual polarized aperture-fed stacked patch antennas 36/high band antenna array elements 12 and the single low band antenna array element 18 on a shared aperture unit cell 34, the dual band antenna array 11 may be expanded or enlarged to an arbitrary size. FIG. 6 illustrates an exemplary larger array that is comprised of four rows 40 and four columns 42 of the shared aperture unit cells 34. Considered across the entirety of the dual band antenna array 11, there may be eight equally spaced rows 14 and eight equally spaced columns 16 of individual high band antenna array elements 12. In particular, there is first row 14a, a second row 14b, a third row 14c, a fourth row 14d, a fifth row 14e, a sixth row 14f, a seventh row 14g, and an eighth row 14h. Additionally, there is a first column 16a, a second column 16b, a third column 16c, a fourth column 16d, a fifth column 16e, a sixth column 16f, a seventh column 16g, and an eighth column 16h.

The low band antenna array elements 18 may be considered as arranged in equally spaced rows 20 and columns 22. In particular, the illustrated example of FIG. 6 shows four rows 20 of the low band antenna array elements 18, including a first row 20a, a second row 20b, a third row 20c, and a fourth row 20d. There are also four columns 22 of the low band antenna array elements 18, including a first column 22a, a second column 22b, a third column 22c, and a fourth column 22d.

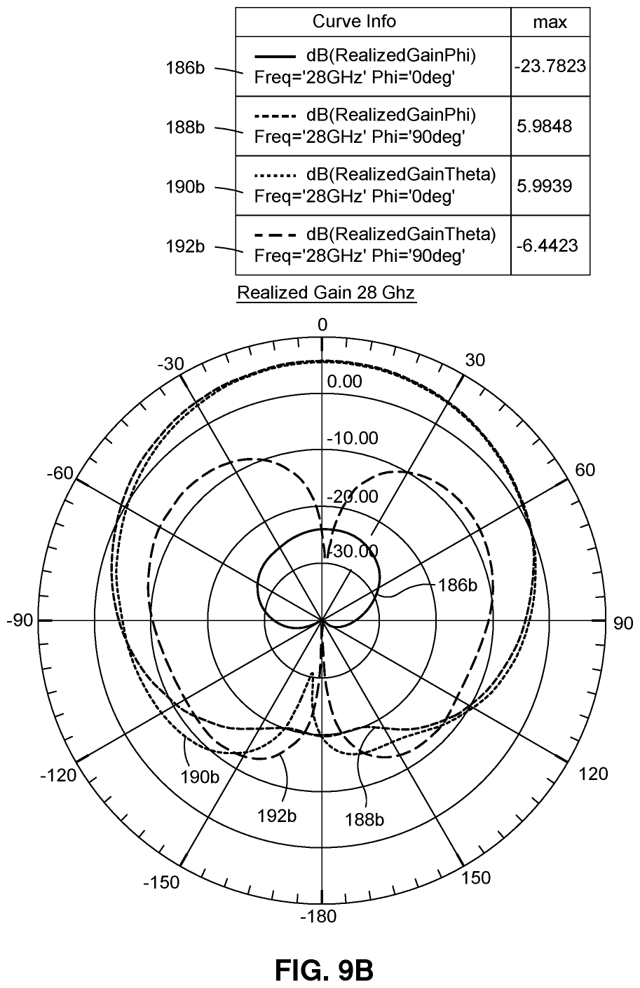

Referring briefly back to FIGS. 1 and 2, one embodiment of the dual/tri-band antenna array 10, and the shared aperture unit cells 24 constituting the same, includes a low band antenna array element 18. As best shown in the detailed view of FIG. 7, the low band antenna array element 18 may be a dual-polarized strip patch dipole antenna 134. In the context of the dual/tri-band antenna array 10, the dual-polarized strip patch dipole antenna 134 is understood to include elements tuned for operating with the 5G mmWave low band (LB) of 24.25 GHz to 29.5 GHz. Nevertheless, it will be appreciated by those having ordinary skill in the art that the dual-polarized strip patch dipole antenna 134 may be adapted to operating in other microwave frequency bands.

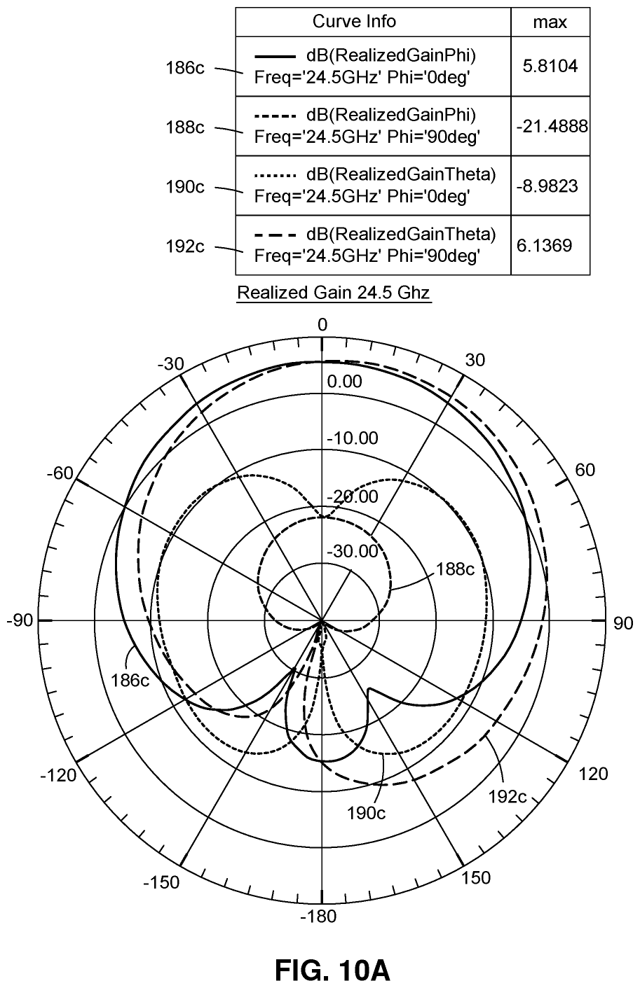

Whether as the entirety of the dual/tri-band antenna array 10, as a single shared aperture unit cell 24, or as an individual antenna element, the dual-polarized strip patch dipole antenna 134 is implemented as a multi-layer laminate structure 136 using conventional laminate manufacturing processes. Referring now to the side view of FIG. 8, the dual-polarized strip patch dipole antenna 134 includes an antenna ground layer 138, also referred to as layer L4. The antenna ground layer 138 is understood to be a ground plane, and thus it is a metal/conductive layer. This embodiment of the dual-polarized strip patch dipole antenna 134 may be implemented over a total of four metal layers, with substrate layers in between. Above the L4 ground layer 138 is metal layer 140, also referred to as L3. Between L4 and L3 there may be a substrate layer 142. Above L3 metal layer 140 is metal layer 144, also referred to as L2, with a substrate layer 146 in between. Next, above L2 metal layer 144 is a metal layer 148 referred to as L1, with a substrate layer 150 in between. The substrate layers 142, 146, and 150 may be a dielectric material, or air.

Different parts of the dual-polarized strip patch dipole antenna 134 are implemented on different metal layers. The high band antenna array element 12 dual-polarized magneto-electric dipole antenna 44 in the shared aperture unit cell 24 can be implemented across three layers, which is a subset of layers of the exemplary embodiment of the low band antenna array element 18/dual-polarized strip patch dipole antenna 134. In such case, notwithstanding the reference to the same layer number (e.g., L2, L3, L4), the layer for the dual-polarized strip patch dipole antenna 134 may be implemented on a different corresponding layer for the dual-polarized magneto-electric dipole antenna 44. As a general matter, references to different metal and substrate layers L1-L3 or L1-L4 is understood to be specific to the particular implementation of the antenna element and is not necessarily intended to be a common reference for both the dual-polarized magneto-electric dipole antenna 44 and the dual-polarized strip patch dipole antenna 134.

As shown in FIGS. 7 and 8, the dual-polarized strip patch dipole antenna 134 is generally defined by a main cross-patch dipole 152. In turn, the main cross-patch dipole 152 includes a vertical strip patch dipole element 154 that is implemented on the L2 metal layer 144. Underneath the vertical strip patch dipole element 154 is a horizontal strip patch dipole element 156 that is implemented on the L3 metal layer 140. Additionally, the horizontal strip patch dipole element 156 is oriented perpendicularly relative to the vertical strip patch dipole element 154. The vertical strip patch dipole element 154 is an elongate, rectangular strip generally defined by an upper end 158, and opposed bottom end 160, and a center portion 162. Similarly, the horizontal strip patch dipole element 156 is an elongate, rectangular strip generally defined by a right end 164, an opposed left end 166, and a central portion 168. The respective central portions 162, 168 of the vertical strip patch dipole element 154 and the horizontal strip patch dipole element 156 are understood to be in an overlapping relationship.

The dual-polarized strip patch dipole antenna 134 also includes a vertical strip patch via 170 that is connected to the vertical strip patch dipole element 154 and the antenna ground layer 138. Thus, the vertical strip patch via 170 extends from L2 metal layer 144 to the L4 antenna ground layer 138. The vertical strip patch via 170 is positioned toward the upper end 158 of the vertical strip patch dipole element 154, though in the illustrated embodiment, closer to the central portion 162 than the upper end 158. The depicted positioning of the vertical strip patch via 170 is presented by way of example only and not of limitation, and any other suitable positioning relative to the vertical strip patch dipole element 154 may be substituted. The vertical strip patch dipole element 154 and the vertical strip patch via 170 together define a dipole for the horizontal polarization.

There is also a horizontal strip patch via 172 connected to the horizontal strip patch dipole element 156 and the antenna ground layer 138. The horizontal strip patch via 172 accordingly extends from the L3 metal layer 140 to the L4 antenna ground layer 138. The horizontal strip patch via 172 is positioned toward the left end 166 of the horizontal strip patch dipole element 156, though closer to the central portion 168 than the left end 166. The positioning of the horizontal strip patch via 172 is presented by way of example only, and similar to the positioning of the horizontal strip patch via 172, any other suitable positioning relative to the respective horizontal strip patch dipole element 156 may be employed. The horizontal strip patch dipole element 156 and the horizontal strip patch via 172 together define a dipole for the horizontal polarization.

In order to achieve a wider antenna bandwidth, embodiments of the dual-polarized strip patch dipole antenna 134 further contemplates a parasitic cross-patch dipole 174 implemented on the top L1 metal layer 148. The parasitic cross-patch dipole 174 has a generally flat structure with a vertical segment 176 and a horizontal segment 178 that overlaps the vertical strip patch dipole element 154 and the horizontal strip patch dipole element 156, respectively. In other words, the parasitic cross-patch dipole 174 may be centered on the cross-shaped aggregate structure defined by the intersecting vertical strip patch dipole element 154 and the horizontal strip patch dipole element 156, and in a coaxial relationship. The width of the vertical and horizontal segments 176, 178 are understood to be less than that of the vertical and horizontal strip patch dipole elements 154, 156, while the ends of the parasitic cross-patch dipole 174 extend beyond the ends of the vertical and horizontal strip patch dipole elements 154, 156, e.g. the each of the extensions of the parasitic cross-patch dipole 174 are longer than the corresponding vertical strip patch dipole element 154 and the horizontal strip patch dipole element 156. The foregoing structural relationships are exemplary only, and other embodiments may substitute different dimensions or dimensional relationships.

The vertical segment 176 and the horizontal segment 178 are perpendicular to each other and an intersecting region 180 corresponds to the center of the cross-shaped structure that is the parasitic cross-patch dipole 174. Connected to this intersecting region 180 is a cross-patch via 182 that extends from the L1 metal layer 148 and the parasitic cross-patch dipole 174 implemented thereon, to the L2 metal layer 144 on which the vertical strip patch dipole element 154 is implemented. As illustrated, the cross-patch via 182 is located at the central portion 162 of the vertical strip patch dipole element 154. The dimensions of the cross-patch via 182, as well as those of the parasitic cross-patch dipole 174, are understood to be optimized for the best/minimal input return loss (S11) performance in the desired frequency band 24.25 to 29.5 GHz.

When a structure is modified by the term “vertical” or “horizontal” per the foregoing or in other embodiments of the low band antenna array element 18, it is to be understood that such modifiers are applicable only in the relative sense as defining a relationship between one feature and another, not in the absolute sense that such structure is horizontal or vertical. Furthermore, reference to vertical and horizontal are made relative to the view presented in FIG. 7. For instance, the horizontal strip patch dipole element 156 may appear vertical from a different viewpoint, so in such case, the structure may be aptly referred to as a vertical strip patch dipole element. It is to be understood, however, that vertical and horizontal may refer to the vertical and horizontal polarization of the microwave signals received and radiated from specific dipole elements. An overlap in the use of the modifier “vertical” and “horizontal” is merely coincidental, as the relative structural relationship between two dipole elements is independent of the polarization.

The vertical strip patch dipole element 154 and the horizontal strip patch dipole element 156 are excited with feeding probes, and specifically a vertical strip patch feeding probe via 185a, and a horizontal strip patch feeding probe via 185b. The vertical strip patch feeding probe via 185a extends from the L4 metal layer/antenna ground layer 138 to the L2 metal layer 144. To this end, the L4 metal layer/antenna ground layer 138 defines an aperture 187a, 187b through which the vertical strip patch feeding probe via 185a and horizontal strip patch feeding probe via 185b passes. The horizontal strip patch feeding probe via 185b extends from the L4 metal layer/antenna ground layer 138 to the L3 metal layer 140. As best shown in FIG. 7, the vertical strip patch feeding probe via 185a is positioned offset from the central portion 162 of the vertical strip patch dipole element 154, and roughly centered between the central portion 162 and the bottom end 160. However, this feature is optional, and it is understood that the specific positioning along the vertical strip patch dipole element 154 may be varied depending on optimization. The horizontal strip patch feeding probe via 185b is positioned offset from the central portion 168 of the horizontal strip patch dipole element 156. The specific connection point between the feeding probe vias 185 and the corresponding strip patch dipole elements 154, 156 may be varied without departing from the scope of the present disclosure.

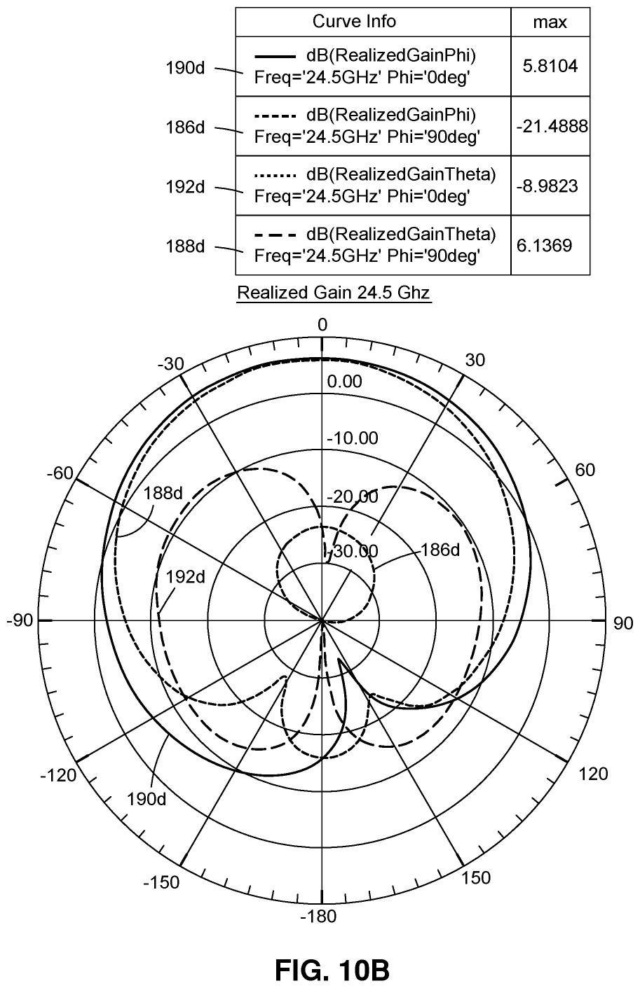

The antenna radiation plot of FIG. 9A illustrates the simulated performance of the dual-polarized strip patch dipole antenna 134 at the upper end of the 5G mmWave low band (e.g., 28 GHz) with a horizontal polarization. A first plot 186a is a sweep of gain of the component of radiated wave with the desired polarization (co-pol gain) values in the azimuth plane (φ=0°), while a second plot 188a is a sweep of gain of the component of radiated wave with the undesired polarization (cross-pol gain) values in the elevation plane (φ=90°). A third plot 190a is a sweep of cross-pol gain values in the azimuth plane, and a fourth plot 192a is a sweep of co-pol gain values in the elevation plane.

The antenna radiation plot of FIG. 9B illustrates the simulated performance of the dual-polarized strip patch dipole antenna 134 at the upper end of 5G mmWave low band operation at 28 GHz with a vertical polarization. A first plot 186b is a sweep of cross-pol gain values in the azimuth plane, while a second plot 188b is a sweep of co-pol gain values in the elevation plane. A third plot 190b is a sweep of co-pol gain values in the azimuth plane, and a fourth plot 192b is a sweep of cross-pol gain values in the elevation plane.

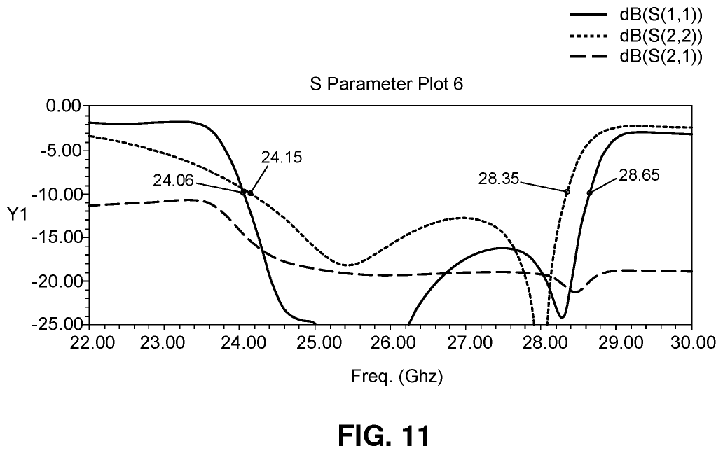

The antenna radiation plot of FIG. 10A illustrates the simulated performance of the dual-polarized strip patch dipole antenna 134 at the lower end of the 5G mmWave low band (e.g., 24.5 GHz) with a horizontal polarization. A first plot 186c is a sweep of co-pol gain values in the azimuth plane, while a second plot 188c is a sweep of cross-pol gain values in the elevation plane. A third plot 190c is a sweep of cross-pol gain values in the azimuth plane, and a fourth plot 192c is a sweep of co-pol gain values in the elevation plane.

The antenna radiation plot of FIG. 10B illustrates the simulated performance of the dual-polarized strip patch dipole antenna 134 at 24.5 GHz with a vertical polarization. A first plot 186d is a sweep of cross-pol gain values in the elevation plane, while a second plot 188d is a sweep of co-pol gain values in the elevation plane. A third plot 190d is a sweep of co-pol gain values in the azimuth plane, and a fourth plot 192d is a sweep of cross-pol gain values in the azimuth plane.

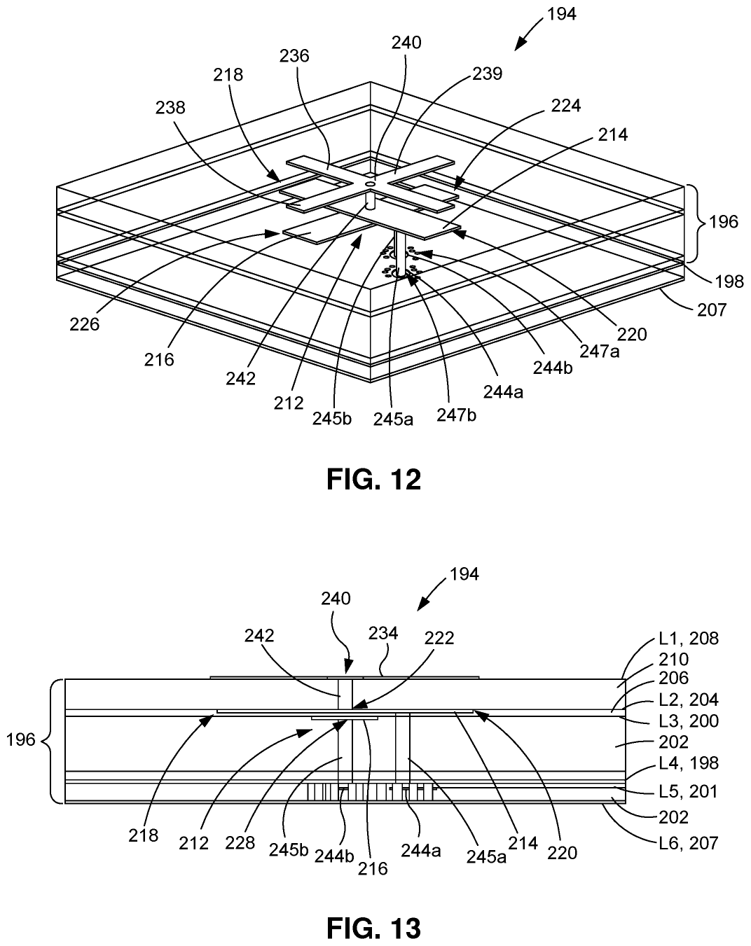

The graph of FIG. 11 shows the return loss/reflection coefficient of the dual-polarized strip patch dipole antenna 134 at the vertical polarization feeding probe (S11), at the horizontal polarization feeding probe (S22), and the isolation between the vertical strip patch dipole element 154 and the horizontal strip patch dipole element 156 (S21).

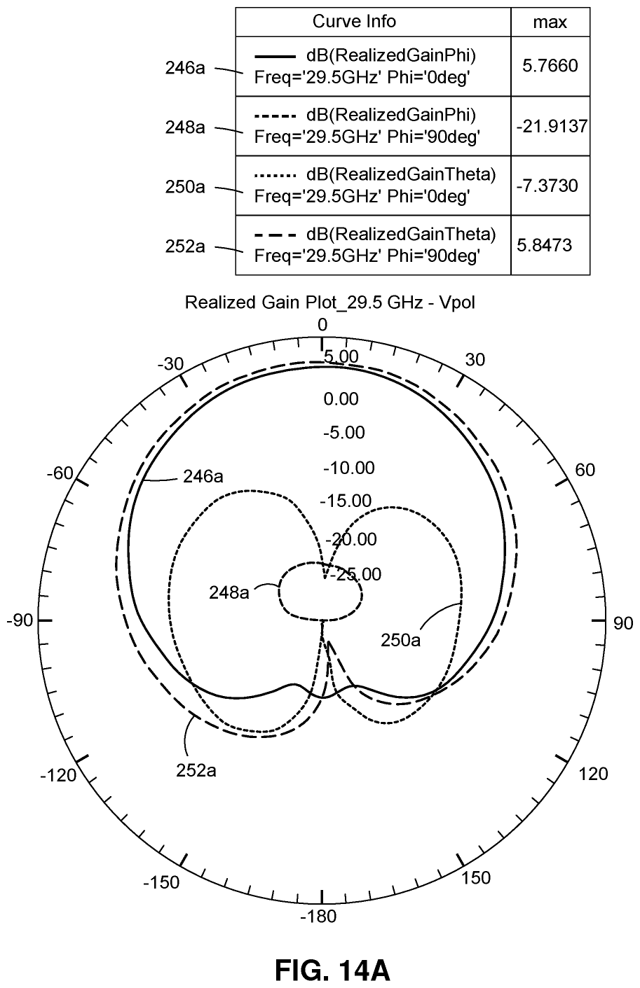

As indicated above, the dual/tri-band antenna array 10 and the shared aperture unit cells 24 constituting the same includes the low band antenna array element 18. In addition to the embodiment of the dual-polarized strip patch dipole antenna 134 considered above, the present disclosure contemplates another embodiment of the low band antenna array element 18. With reference to FIG. 12, there may be another variation of the dual-polarized strip patch dipole antenna 194. Like the first embodiment, this second embodiment may be tuned for operating in the 5G mmWave low band (LB) of 24.25 GHz to 29.5 GHz, in both horizontal and vertical polarization.

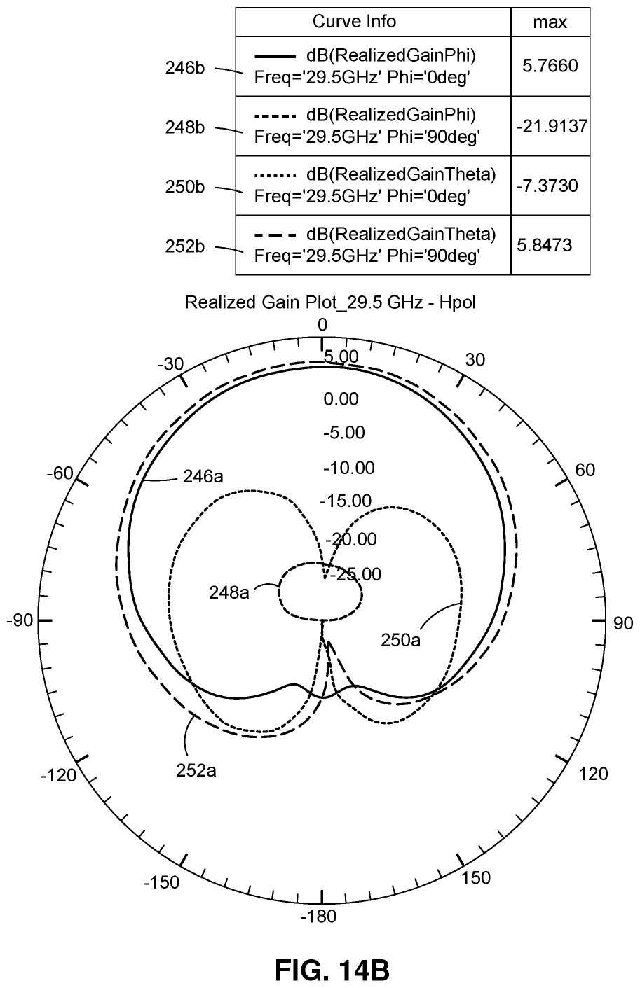

Again, the dual-polarized strip patch dipole antenna 194 may be is implemented as a multi-layer laminate structure 196 using conventional laminate manufacturing processes. As best shown in the side view of FIG. 13, the dual-polarized strip patch dipole antenna 194 includes an antenna ground layer 198, also referred to as layer L4. The antenna ground layer 198 is understood to be a ground plane, and thus it is a metal/conductive layer. This second embodiment of the dual-polarized strip patch dipole antenna 194 may be implemented over a total of six metal layers, with substrate layers in between. In further detail, the dual-polarized strip patch dipole antenna 194 includes a trace feed to the antenna patches, and thus includes two additional layers beyond the four that are common to the first embodiment of the strip patch dipole antenna 134.

Above the L4 antenna ground layer 198 is a metal layer 200, also referred to as layer L3. Between layers L4 and L3 there may be a substrate layer 202. Above the L3 metal layer 200 is a metal layer 204, also referred to as a layer L2, with a substrate layer 206 in between. Next, above the L2 metal layer 204 is a metal layer 208 referred to as L1, with a substrate layer 210 in between.

Below the L4 antenna ground layer 198 is a feedline metal layer 201, also referred to as layer L5, as well as a second antenna ground layer 207, referred to as layer L6. In between layer L5 and L6 there may be another substrate layer 209. The substrate layers 202, 203, 206, 209, and 210 may be a dielectric material, or air.

Different parts of the dual-polarized strip patch dipole antenna 134 are implemented on different metal layers. As discussed earlier, the high band antenna array element 12/dual-polarized magneto-electric dipole antenna 44 in the shared aperture unit cell 24 can be implemented across five layers, which is a different number of layers than this exemplary second embodiment of the low band antenna array element 18/dual-polarized strip patch dipole antenna 194. In such case, notwithstanding the reference to the same layer number (e.g., L2, L3, L4), the layer for the dual-polarized strip patch dipole antenna 134 may be implemented on a different corresponding layer for the dual-polarized magneto-electric dipole antenna 44. The references to different metal and substrate layers L1-L5 or L1-L6 is understood to be specific to the particular implementation of the antenna element and is not intended to be a common reference for both the dual-polarized magneto-electric dipole antenna 44 and the dual-polarized strip patch dipole antenna 194.

As shown in FIGS. 12 and 13, the dual-polarized strip patch dipole antenna 194 is generally defined by a main cross-patch dipole 212 that includes a vertical strip patch dipole element 214 that is implemented on the L2 metal layer 204. Underneath the vertical strip patch dipole element 214 is a horizontal strip patch dipole element 216 that is implemented on the L3 metal layer 200. The horizontal strip patch dipole element 216 is oriented perpendicularly relative to the vertical strip patch dipole element 214. The vertical strip patch dipole element 214 is an elongate, rectangular strip generally defined by an upper end 218, and opposed bottom end 220, and a center portion 222. Similarly, the horizontal strip patch dipole element 216 is an elongate, rectangular strip generally defined by a right end 224, an opposed left end 226, and a central portion 228. The respective central portions 222, 228 of the vertical strip patch dipole element 214 and the horizontal strip patch dipole element 216 are understood to be in an overlapping relationship.

In order to achieve a wider antenna bandwidth, embodiments of the dual-polarized strip patch dipole antenna 194 further contemplates a parasitic cross-patch dipole 234 implemented on the top L1 metal layer 208. The parasitic cross-patch dipole 234 has a generally flat structure with a vertical segment 236 and a horizontal segment 238 that overlaps the vertical strip patch dipole element 214 and the horizontal strip patch dipole element 216, respectively. The vertical segment 236 and the horizontal segment 238 are perpendicular to each other and an intersecting region 240 corresponds to the center of the cross-shaped structure that is the parasitic cross-patch dipole 234. Connected to this intersecting region 180 is a cross-patch via 242 that extends from the L1 metal layer 208 and the parasitic cross-patch dipole 234 implemented thereon, to the L2 metal layer 204 on which the vertical strip patch dipole element 214 is implemented. As illustrated, the cross-patch via 242 is located at the central portion 222 of the vertical strip patch dipole element 214. The dimensions of the cross-patch via 242, as well as those of the parasitic cross-patch dipole 234, are understood to be optimized for the best/minimal input return loss (S11) performance in the desired frequency band 24.25 to 29.5 GHz.

The second embodiment of the dual-polarized strip patch dipole antenna 194 contemplates the exciting of the vertical strip patch dipole element 214 and the horizontal strip patch dipole element 216 with strip patch vias 245 that are fed via a microstrip line 244. In further detail, there is a vertical strip patch via 245a that is connected to a vertical polarization microstrip line 244a (so referenced because it is part of the chain of components that excites the vertical strip patch dipole element 214) and a horizontal strip patch via 245b that is connected to a horizontal polarization microstrip line 244b (again, so referenced because it is part of the chain of components that excites the vertical polarization strip patch dipole element 216). It is to be appreciated, however, that the first embodiment of the dual-polarized strip patch dipole antenna 134 may similarly excite the cross-patch dipole through a microstrip feed, though one difference between the first embodiment and the second embodiment is the exclusion of the grounding vias to the ground layer. The microstrip lines 244 are understood to be implemented on the L5 metal layer 201. The vertical strip patch via 245a is connected to the vertical strip patch dipole element 214 and extends between the L2 metal layer 204 and the L5 metal layer 201, and the horizontal strip patch via 245b is connected to the horizontal strip patch dipole element 216 and extends between the L3 metal layer 200 and the L5 metal layer 201. The specific connection point between the strip patch vias 245 and the corresponding strip patch dipole elements 214, 216 may be varied without departing from the scope of the present disclosure. Because the strip patch vias 245 extend through the first antenna ground layer 198, openings 247 for each, including a first opening 247a corresponding to the vertical strip patch via 245a, and a second opening 247b corresponding to the horizontal strip patch via 245b, may be defined by the L4 metal layer.

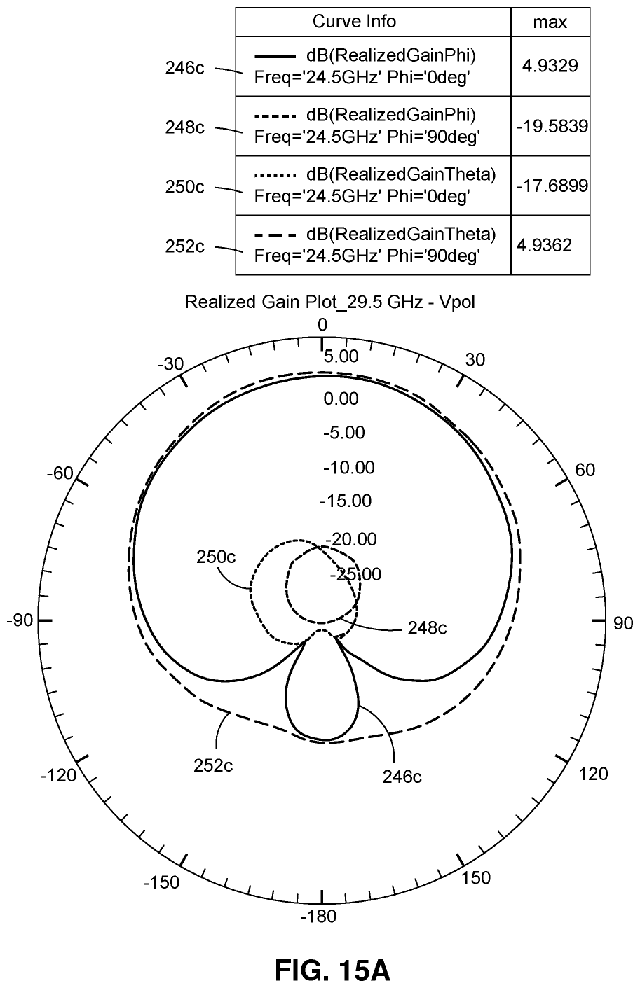

The antenna radiation plot of FIG. 14A illustrates the simulated performance of the dual-polarized strip patch dipole antenna 194 at 29.5 GHz with a vertical polarization. A first plot 246a is a sweep of co-pol gain values in the azimuth plane (φ=0°, while a second plot 248a is a sweep of cross-pol gain values in the elevation plane (φ=90°. A third plot 250a is a sweep of cross-pol gain values in the azimuth plane, and a fourth plot 252a is a sweep of co-pol gain values in the elevation plane.

The antenna radiation plot of FIG. 14B illustrates the simulated performance of the dual-polarized strip patch dipole antenna 194 at 29.5 GHz with a horizontal polarization. A first plot 246b is a sweep of co-pol gain values in the azimuth plane, while a second plot 248b is a sweep of cross-pol gain values in the elevation plane. A third plot 250b is a sweep of cross-pol gain values in the azimuth plane, and a fourth plot 252b is a sweep of co-pol gain values in the elevation plane.

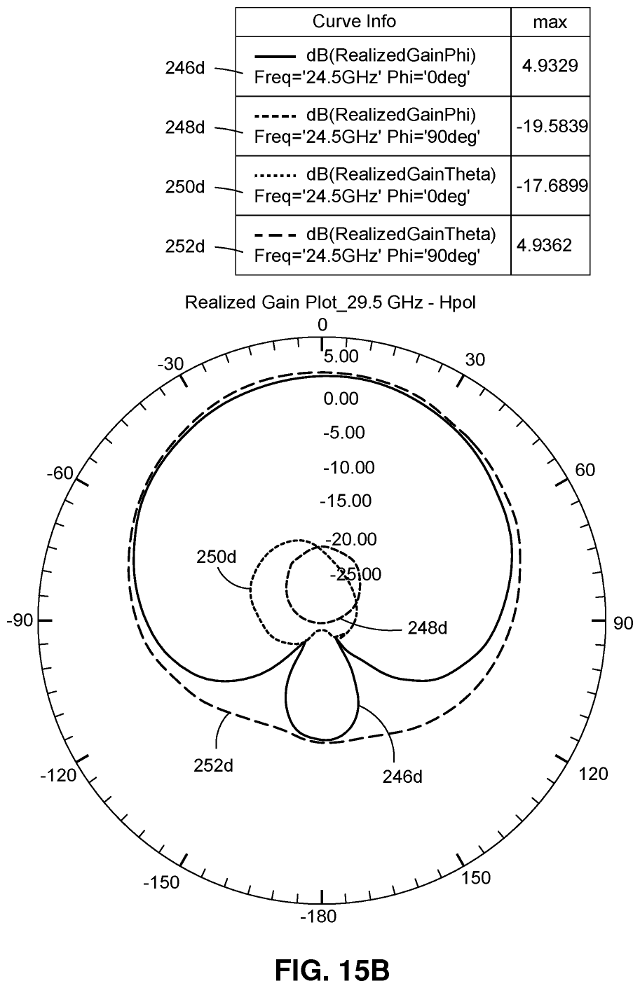

The antenna radiation plot of FIG. 15A illustrates the simulated performance of the dual-polarized strip patch dipole antenna 194 at 24.5 GHz with a vertical polarization. A first plot 246c is a sweep of co-pol gain values in the azimuth plane, while a second plot 248c is a sweep of cross-pol gain values in the elevation plane. A third plot 250c is a sweep of cross-pol gain values in the azimuth plane, and a fourth plot 252c is a sweep of co-pol gain values in the elevation plane.

The antenna radiation plot of FIG. 15B illustrates the simulated performance of the dual-polarized strip patch dipole antenna 194 at 24.5 GHz with a horizontal polarization. A first plot 246d is a sweep of co-pol gain values in the azimuth plane, while a second plot 248d is a sweep of cross-pol gain values in the elevation plane. A third plot 250d is a sweep of cross-pol gain values in the azimuth plane, and a fourth plot 252d is a sweep of co-pol gain values in the elevation plane.

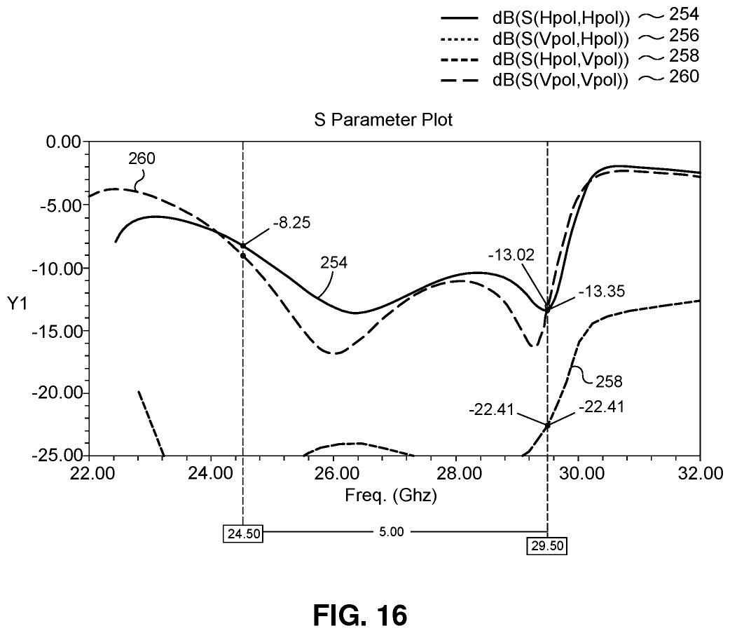

The graph of FIG. 16 shows various performance parameters of the dual-polarized strip patch dipole antenna 194. Specifically, a first plot 254 is of the return loss/reflection coefficient at the horizontal polarization microstrip line 244b (S(Hₚₒₗ, Hₚₒₗ)). In a second plot 256, the isolation between the horizontal polarization microstrip line 244b and the vertical polarization microstrip line 244a (S(Hₚₒₗ, Vₚₒₗ)). A third plot 258 shows the isolation between the vertical polarization microstrip line 244a and the horizontal polarization microstrip line 244b ((S(Vₚₒₗ, Hₚₒₗ)). Lastly, a fourth plot 260 shows the input return loss/reflection coefficient at the vertical polarization microstrip line 244a ((S(Vₚₒₗ, Vₚₒₗ)).

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

1-24. (canceled)

25. A dual-polarized antenna, comprising:
a first antenna ground layer;
a vertical strip patch dipole element on a first intermediate layer;
a vertical strip patch via connected to the vertical strip patch dipole element and the first antenna ground layer;
a vertical strip patch feeding probe exciting the vertical strip patch dipole element;
a horizontal strip patch dipole element on a second intermediate layer oriented perpendicularly to the vertical strip patch dipole element and overlapping at respective central portions of the horizontal strip patch dipole element and the vertical strip patch dipole element;
a horizontal strip patch via connected to the horizontal strip patch dipole element and the first antenna ground layer;
a horizontal strip patch feeding probe exciting the horizontal strip patch dipole element;
a parasitic cross-patch dipole on a top layer and centered above the horizontal strip patch dipole element and the vertical strip patch dipole element; and
a cross-patch via connected to the parasitic cross-patch dipole and the vertical strip patch dipole element.

26. The dual-polarized antenna of claim 25, wherein the cross-patch via is connected to the parasitic cross-patch dipole at a center thereof.

27. The dual-polarized antenna of claim 25, wherein the vertical strip patch via is connected to the vertical strip patch dipole element at a location offset from the central portion thereof, and the horizontal strip patch via is connected to the horizontal strip patch dipole element at a location offset from the central portion thereof.

28. The dual-polarized antenna of claim 25, wherein the vertical strip patch feeding probe is positioned relative to the vertical strip patch dipole element offset from the central portion thereof, and the horizontal strip patch feeding probe is positioned relative to the horizontal strip patch dipole element offset from the central portion thereof.

29. A dual-polarized antenna, comprising:
a first antenna ground layer;
a vertical strip patch dipole element on a first intermediate layer;
a vertical strip patch via connected to the vertical strip patch dipole element and the first antenna ground layer;
a vertical strip patch feeding probe exciting the vertical strip patch dipole element;
a vertical strip patch microstrip line connected to the vertical strip patch feeding probe;
a horizontal strip patch dipole element on a second intermediate layer oriented perpendicularly to the vertical strip patch dipole element and overlapping at respective central portions of the horizontal strip patch dipole element and the vertical strip patch dipole element;
a horizontal strip patch via connected to the horizontal strip patch dipole element and the first antenna ground layer;
a horizontal strip patch feeding probe exciting the horizontal strip patch dipole element;
a horizontal strip patch microstrip line connected to the horizontal strip patch feeding probe;
a parasitic cross-patch dipole on a top layer and centered above the horizontal strip patch dipole element and the vertical strip patch dipole element; and
a cross-patch via connected to the parasitic cross-patch dipole and the vertical strip patch dipole element.

30. The dual-polarized antenna of claim 29, further comprising:
a first via connecting the vertical strip patch microstrip line to the vertical strip patch dipole element; and
a second via connecting the horizontal strip patch microstrip line to the horizontal strip patch dipole element.

31. The dual-polarized antenna of claim 29, further comprising:
a second antenna ground layer underneath the vertical strip patch microstrip line and the horizontal strip patch microstrip line.

32. A dual-polarized antenna, comprising:
a main cross-patch dipole defined by a horizontal polarization patch element and a vertical polarization patch element offset from and oriented perpendicularly to each other;
patch element vias connected to the horizontal polarization patch element and to the vertical polarization patch element; and
a parasitic cross-patch dipole centered above the main cross-patch dipole.

33. The dual-polarized antenna of claim 32, further comprising a first antenna ground layer.

34. The dual-polarized antenna of claim 33, wherein the patch element vias are connected to the first antenna ground layer.

35. The dual-polarized antenna of claim 33, further comprising a second antenna ground layer.

36. The dual-polarized antenna of claim 35, further comprising:
a first microstrip line exciting the vertical polarization patch element; and
a second microstrip line exciting the horizontal polarization patch element;
wherein the first microstrip line and the second microstrip line are disposed between the first antenna ground layer and the second antenna ground layer.

37. The dual-polarized antenna of claim 32, further comprising:
a vertical polarization feeding probe exciting the vertical polarization patch element; and
a horizontal polarization feeding probe exciting the horizontal polarization patch element.

38. The dual-polarized antenna of claim 32, further comprising a cross-patch via connected to the parasitic cross-patch dipole and the main cross-patch patch dipole.

39. A radio frequency transmit-receive module comprising:
a beamformer integrated circuit; and
a multi-layer laminate structure antenna, including:
a main cross-patch dipole defined by a horizontal polarization patch element and a vertical polarization patch element offset from and oriented perpendicularly to each other;
patch element vias connected to the horizontal polarization patch element and to the vertical polarization patch element; and
a parasitic cross-patch dipole centered above the main cross-patch dipole.

40. The radio frequency transmit-receive circuit of claim 39, wherein the multi-layer laminate structure antenna includes a first antenna ground layer.

41. The radio frequency transmit-receive circuit of claim 40, wherein the multi-layer laminate structure antenna includes a second antenna ground layer.

42. The radio frequency transmit-receive circuit of claim 41, wherein the multi-layer laminate structure antenna includes:
a first microstrip line exciting the vertical polarization patch element; and
a second microstrip line exciting the horizontal polarization patch element;
wherein the first microstrip line and the second microstrip line are disposed between the first antenna ground layer and the second antenna ground layer.

43. The radio frequency transmit-receive circuit of claim 40, wherein the multi-layer laminate structure antenna includes:
a vertical polarization feeding probe exciting the vertical polarization patch element; and
a horizontal polarization feeding probe exciting the horizontal polarization patch element.
